(19) United States
(12) Patent Application Publication
(10) Pub. No.: US 2025/0309555 A1
(43) Pub. Date: Oct. 2, 2025

(54) REFLECTION PANEL AND ELECTROMAGNETIC-WAVE REFLECTING APPARATUS

(71) Applicant: AGC Inc., Tokyo (JP)

(72) Inventor: Kumiko KAMBARA, Tokyo (JP)

(73) Assignee: AGC Inc., Tokyo (JP)

(21) Appl. No.: 19/238,110

(22) Filed: Jun. 13, 2025

Related U.S. Application Data
(63) Continuation of application No. PCT/JP2023/044426, filed on Dec. 12, 2023.

(30) Foreign Application Priority Data
Dec. 21, 2022 (JP) 2022-204383

(51) Int. Cl. H01Q 15/14

(52) U.S. Cl. CPC H01Q 15/148

(57) ABSTRACT

A reflection panel and an electromagnetic-wave reflecting apparatus having the advantages of both a meta-surface and specular reflection are provided. A reflection panel comprises: a first panel configured to specularly reflect an electromagnetic wave in a desired band selected from a frequency band of 1 GHz or higher and 300 GHz or lower; and a second panel including a meta-surface having a controlled reflection characteristic, wherein an interval between the first panel and the second panel in a direction perpendicular to a panel surface is an interval of 0.0 mm or longer and less than 100.0 mm.

### INCORPORATION BY REFERENCE

This application is based upon and claims the benefit of priority from Japanese patent application No. 2022-204383, filed on Dec. 21, 2022, and PCT application No. PCT/JP2023/044426 filed on Dec. 12, 2023, the disclosure of which is incorporated herein in its entirety by reference.

### BACKGROUND

In the fifth-generation (hereinafter “5G”) mobile communication standard, high-speed and large-capacity communication is expected. However, since radio waves having a highly straight-traveling property are used in 5G, there may be places where such radio waves are less likely to reach. Means for sending radio waves to target terminal apparatuses or radio devices are required in a place where a plurality of metal machines are present, such as a factory, or in a place where a large number of reflections occur from wall surfaces or roadside trees, such as an area with a plurality of buildings. The above means are also required in a place where a Non-Line-Of-Sight (NLOS) spot in which an antenna of a base station cannot be directly seen is generated, such as a medical site, an event venue, and a large commercial facility. A configuration in which electromagnetic reflecting apparatuses are arranged along at least a part of a production line has been proposed (see, e.g., International Patent Publication No. WO 2021/199504).

In recent years, an artificial reflection surface called a “meta-surface” has been developed. The meta-surface is formed of periodic structures or patterns that are finer than the wavelength and designed so as to reflect radio waves in a desired direction (see, e.g., Diaz-Rubio et al., Sci. Adv. 2017:3: e1602714 1). Since a meta-surface makes it possible to obtain a desired reflection angle while maintaining a planar arrangement/configuration, it can effectively function as a reflector even in an environment in which there is not enough space to install a large number of electromagnetic-wave reflection panels.

### SUMMARY

In general, as the size of a reflector increases, the gain thereof increases, and consequently a radio wave reflection effect and an improvement effect of a propagation environment are enhanced. However, a reflector of a meta-surface requires processing of precise metal and resin layers smaller than a wavelength of a 5G radio wave. The typical size of the reflector is about 150 mm to 500 mm on a side. Further, unlike a specular reflection surface, it is difficult to bring an electrode reflection efficiency of the meta-surface close to 100%. For the above reasons, the reflector of the meta-surface alone may not be sufficient to improve a reflection efficiency and a propagation environment. On the other hand, regarding a reflector using specular reflection, there are many options of materials for a conductive layer which is a functional layer, and a limitation on the size thereof is small. In the case of the specular reflection, a large-sized panel can be easily fabricated, good reflection characteristics can be obtained, and a sufficient propagation environment improvement effect can be produced. However, the reflector can reflect only in a direction of regular reflection in relation to the position of a base station, and the reflection angle thereof cannot be controlled. Thus, a place where the reflector is installed is likely to be limited. One of the objects of the present invention is to provide a reflection panel and an electromagnetic-wave reflecting apparatus having the advantages of both a meta-surface and specular reflection.

In an embodiment, a reflection panel comprises:
a first panel configured to specularly reflect an electromagnetic wave in a desired band selected from a frequency band of 1 GHz or higher and 300 GHz or lower; and
a second panel including a meta-surface having a controlled reflection characteristic,
wherein an interval between the first panel and the second panel in a direction perpendicular to a panel surface is an interval of 0.0 mm or longer and less than 100.0 mm.

A reflection panel and an electromagnetic-wave reflecting apparatus having the advantages of both a meta-surface and specular reflection are provided.

The above and other objects, features and advantages of the present disclosure will become more fully understood from the detailed description given hereinbelow and the accompanying drawings.

### BRIEF DESCRIPTION OF DRAWINGS

FIG. 1 is a schematic diagram of an electromagnetic-wave reflecting apparatus using a reflection panel according to an embodiment;

FIG. 2 is a side view of the reflection panel;

FIG. 3 is a schematic diagram of an electromagnetic-wave reflecting fence in which a plurality of electromagnetic-wave reflecting apparatuses are connected to one another;

FIG. 4A is a perspective view showing an example of a holding part that holds a second panel;

FIG. 4B is a schematic side view of FIG. 4A;

FIG. 5 is a diagram showing another example of the holding part that holds the second panel;

FIG. 6 is a diagram showing an example of a configuration of a frame used to hold the second panel in FIG. 5;

FIG. 7 is a diagram showing a state in which the frame holds adjacent reflection panels;

FIG. 8 is a diagram showing another example of the holding part that holds the second panel;

FIG. 9 is a schematic diagram of a layer structure of a first panel;

FIG. 10 is a schematic plan view of a meta-surface of the second panel;

FIG. 11 is a diagram showing an example of a unit pattern constituting the meta-surface;

FIG. 12 is a schematic diagram of a layer structure of the second panel; and

FIG. 13 is a diagram showing an analysis space of the second panel.

### DESCRIPTION OF EMBODIMENTS

In this embodiment, a reflection panel having the advantages of both a meta-surface and specular reflection is provided by combining a first panel using the specular reflection and a second panel of the meta-surface. The first panel using the specular reflection does not require fine patterning, and a panel having a large area is easily fabricated. The second panel having the meta-surface is disposed on one surface of the first panel. The second panel is disposed at a predetermined interval from the surface of the first panel, specifically, at an interval of 0.0 mm or longer and less than 100.0 mm, on a side of the first panel on which an electromagnetic wave is incident. The second panel is positioned on the front surface of the first panel as viewed from an electromagnetic wave incident on the first panel.

It is preferred that the second panel be movably or detachably held on an incident surface side of the first panel, and the second panel can be attached in accordance with the place where the reflection panel is installed, so that the position of the second panel can be adjusted on the first panel. A plane size of the second panel is smaller than that of the first panel, and a plurality of the second panels may be arranged on the incident surface side of the first panel.

Configurations of a reflection panel according to an embodiment and an electromagnetic-wave reflecting apparatus using the reflection panel will be described hereinafter with reference to the drawings. The embodiment described below is merely an example to embody the technical concept of the present invention, and the present invention is thus not limited to the embodiment. The size, the positional relationship, and the like of each member shown in the drawings may be exaggerated in order to facilitate understanding of the invention. In the following description, the same components or functions are denoted by the same names or symbols, and redundant descriptions thereof may be omitted.

### Configurations of a Reflection Panel and an Electromagnetic-Wave Reflecting Apparatus

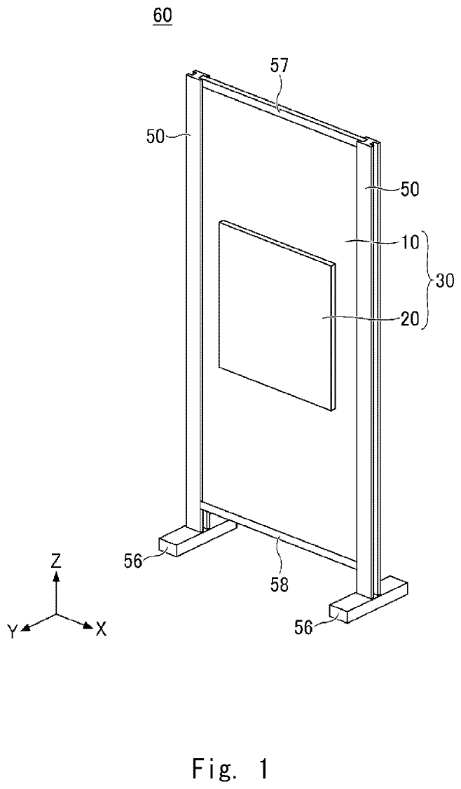

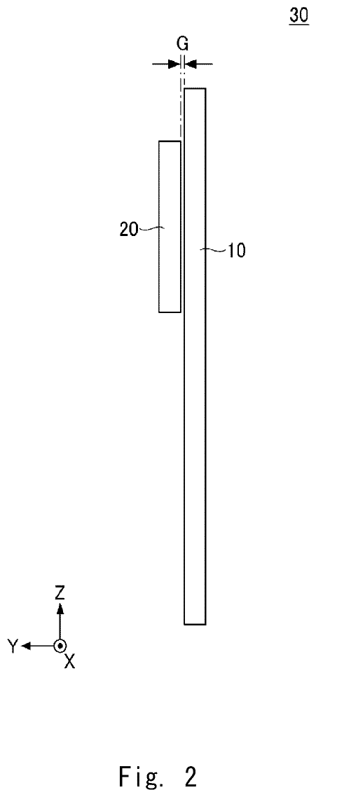

FIG. 1 is a schematic diagram of an electromagnetic-wave reflecting apparatus 60 using a reflection panel 30 according to an embodiment, and FIG. 2 is a side view of the reflection panel 30. In the coordinate systems shown in FIGS. 1 and 2, the plane in which the electromagnetic-wave reflecting apparatus 60 is installed is defined as an XY plane, the height direction orthogonal to the XY plane is defined as a Z direction, and the thickness direction of the reflection panel 30 is defined as a Y direction. The electromagnetic-wave reflecting apparatus 60 is installed at a desired place indoors or outdoors, and the reflection panel 30 reflects an electromagnetic wave of a predetermined frequency selected from a frequency band of 1 GHz or higher and 300 GHz or lower, for example, 1 GHz or higher and 170 GHz or lower.

The reflection panel 30 includes a first panel 10 using specular reflection and a second panel 20 including a meta-surface having a controlled reflection characteristic, and an interval G between the first panel and the second panel in a direction perpendicular to a panel surface is an interval of 0.0 mm or longer and less than 100.0 mm. When the interval G is 0.0 mm, the second panel 20 is in contact with the surface of the first panel 10. A state in which the first panel 10 and the second panel 20 are in contact with each other refers to a state in which there is no air layer which substantially changes a dielectric constant between these two panels, and it is assumed that a gap due to microscopic irregularities of the panel surface can be ignored. The meta-surface having a controlled reflection characteristic reflects an incident electromagnetic wave at a reflection angle different from an incident angle. In an example of a favorable configuration, the second panel 20 is supported so as to be movable relative to the first panel 10 or detachable from the first panel 10. For example, the second panel 20 is suspended by a transparent fishing line or polymer wire, and is disposed at a desired position in the plane of the first panel 10 at an interval within a range of the above-described interval G. A specific example of a configuration in which the second panel 20 is held relative to the first panel 10 will be described later.

The electromagnetic-wave reflecting apparatus 60 includes the reflection panel 30 and frames 50 for holding the reflection panel 30. The frames 50 holds respective ends of the first panel 10 of the reflection panel 30. The electromagnetic-wave reflecting apparatus 60 may further include a top frame 57 for holding the upper end of the reflection panel 30 and a bottom frame 58 for holding the lower end thereof. The frames 50, the top frame 57, and the bottom frame 58 hold the entire periphery of the reflection panel 30, more specifically, the entire periphery of the first panel 10. The frames 50 may be called “side frames” because of the positional relationship with the top frame 57 and the bottom frame 58. The top frame 57 and the bottom frame 58 are not indispensable. However, by providing the top frame 57 and the bottom frame 58, it is possible to ensure the mechanical strength and safety of the first panel and the second panel 20 when the first panel is conveyed, assembled, or installed and the second panel 20 is attached.

When the electromagnetic-wave reflecting apparatus 60 is to be made to stand alone indoors or outdoors, legs 56 may be provided. Although the legs 56 support the lower end of the frames 50 in the example shown in FIG. 1, the legs 56 may be connected to the bottom frame 58. The legs 56 may be fixed to the floor or road surface with screws or the like. The legs 56 may be equipped with movable components such as casters so that they can be moved in the place where the electromagnetic-wave reflecting apparatus 60 is installed. The legs 56 may not be provided, and the entire periphery of the reflection panel 30 may be surrounded by frames, and the electromagnetic-wave reflecting apparatus 60 may be installed obliquely to the wall, ceiling, floor, or the like.

As shown in FIG. 2, the second panel 20 of the reflection panel 30 is disposed at a predetermined interval G from the first panel 10 in the direction perpendicular to the panel surface. The interval G is set within a range of 0.0 mm or longer and less than 100.0 mm in order to maintain a high power reflection efficiency of the reflection panel 30. When the interval G is 100.0 mm or longer, reflection, scattering, etc. occur in a space between the first panel 10 and the second panel 20, and the power reflection efficiency of the second panel 20 decreases, and as a result, the power reflection efficiency of the entire reflection panel 30 decreases beyond an allowable range thereof. The grounds for the above will be described later in detail.

In order to movably hold the second panel 20 on the surface of the first panel 10, it is desirable that the first panel 10 and the second panel 20 be not in physical contact with each other as much as possible while the position of the second panel 20 is being moved. After the position of the second panel 20 is determined, the second panel 20 may be held so as to be in contact with the first panel 10. This is because a thinner air layer between the first panel 10 and the second panel 20 has less influence on the designed reflection characteristic of the second panel 20.

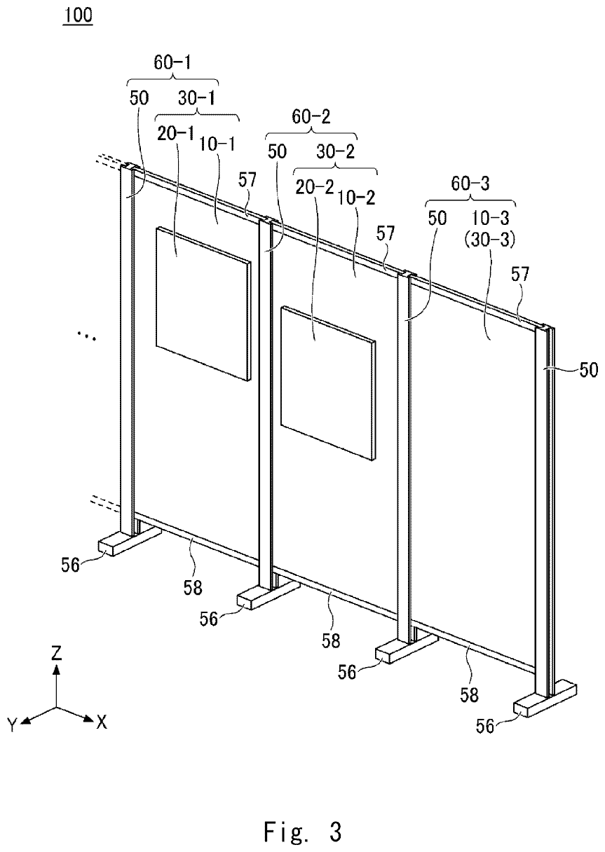

FIG. 3 is a schematic diagram of an electromagnetic-wave reflecting fence 100 in which a plurality of electromagnetic-wave reflecting apparatuses 60 are connected to one another. In the example shown in FIG. 3, electromagnetic-wave reflecting apparatuses 60-1, 60-2, and 60-3 are connected to each other in the lateral (X) direction by means of the frames 50. The electromagnetic-wave reflecting apparatuses 60-1, 60-2, and 60-3 respectively include reflection panels 30-1, 30-2, and 30-3 (may be collectively referred to as “reflection panels 30” as appropriate). In the reflection panels 30-1 and 30-2, second panels 20-1 and 20-2 are respectively attached to first panels 10-1 and 10-2. The second panels 20-1 and 20-2 may be respectively attached onto the first panels 10-1 and 10-2 at the same position or different positions in accordance with an arrival direction of an electromagnetic wave and a direction in which the electromagnetic wave is to be reflected. The plane (vertical and horizontal) size and the reflection characteristic of the second panel 20-1 and the plane size and the reflection characteristic of the second panel 20-2 may be the same as or different from each other. When the size of the panel is defined by the vertical size, the horizontal size, and the thickness, the plane size indicates the vertical and horizontal size. Similarly, the plane size of the first panel 10 indicates the vertical and horizontal size of the panel.

The reflection panel 30-3 of the electromagnetic-wave reflecting apparatus 60-3 is used in a state in which the second panel 20 is detached therefrom. However, like in the cases of the reflection panels 30-1 and 30-2, the second panel 20 may be attached to a first panel 10-3 at a desired position thereon. The number of electromagnetic-wave reflecting apparatuses 60 to be connected to each other is not limited to three; the electromagnetic-wave reflecting fence 100 in which two electromagnetic-wave reflecting apparatuses 60 are connected to each other may be assembled, or four or more electromagnetic-wave reflecting apparatuses 60 may be connected to each other. When a plurality of electromagnetic-wave reflecting apparatuses 60 are connected to each other in the lateral (X) direction, it is desirable that at least a part of the frames 50 be formed of a conductor so that the reflection potential between the adjacent first panels 10-1 and 10-2 or between the first panels 10-2 and 10-3 is made continuous.

A plurality of independent electromagnetic-wave reflecting apparatuses 60 that are not connected to each other may be disposed in a desired direction, to thereby surround a desired space. A single electromagnetic-wave reflecting apparatus 60 and the electromagnetic-wave reflecting fence 100 may be combined with each other, or two or more electromagnetic-wave reflecting fences 100 may be combined with each other, to thereby form a predetermined space. In either case, the second panel 20 may be disposed at a desired position on a desired first panel 10.

### Configuration in Which the Second Panel is Held

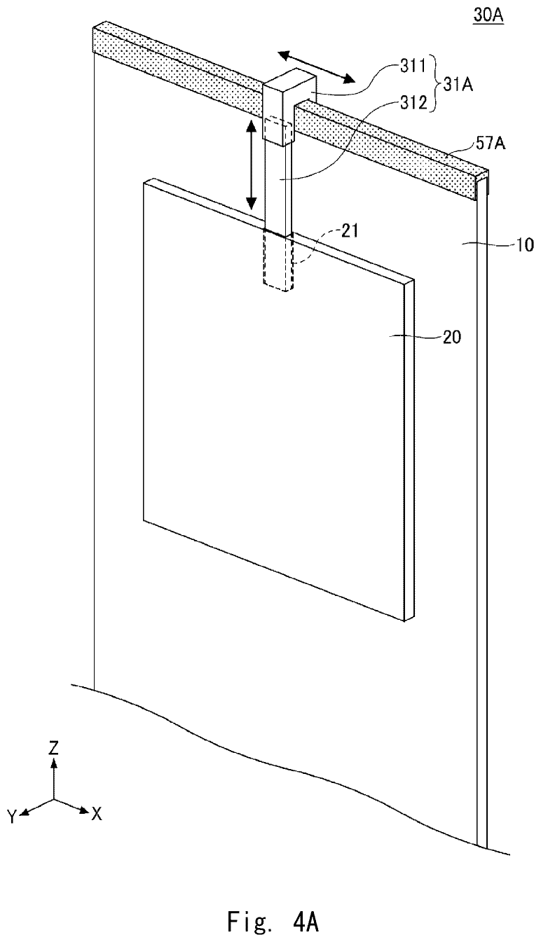

FIG. 4A is a perspective view of a reflection panel 30A including a holding part 31A that holds the second panel 20, and FIG. 4B is a side view of FIG. 4A. The holding part 31A includes a first part 311 which is movable in a first direction of the first panel 10, and a second part 312 which supports the second panel 20 and the length of which can be changed in a second direction of the first panel 10. The first part 311 is movably attached to an edge of the first panel 10 at a desired position thereon. The first part 311 has such a hook-like shape that it can be hooked on an upper end of the first panel 10 or a top frame 57A, and is slidable in the lateral direction (X direction) of the reflection panel 30A.

The second part 312 extends from a tip of the first part 311 opposite to the hook thereof to support the second panel 20. A tip of the second part 312 is fitted into a hole or slit 21 (hereinafter simply referred to as a “hole 21”) provided in the second panel 20 to support the second panel 20. A part where the second part 312 is fitted into the hole 21 may be reinforced with an adhesive. The second part 312 is slidable in the second direction (the Z direction in this example) relative to the first part 311, so that the length of the holding part 31A can be changed in the Z direction. Locks or latches may be provided at predetermined intervals in the second part 312. For the sake of convenience of illustration, the first part 311 and the second part 312 are shown as single-stage sliders, but may be two-stage or more-stage sliders. For example, the second part 312 may have a hollow shell structure, and a rod of a third part may be slid inside the second part 312.

The entire holding part 31A is transparent to wavelengths of electromagnetic waves reflected by the first panel 10 and the second panel 20. Each of the first part 311 and the second part 312 of the holding part 31A preferably has roughly the same dielectric constant and dielectric loss tangent as those of the dielectric layers used in the first panel 10 and the second panel 20, and minimizes an influence on the reflection characteristics of the first panel 10 and the second panel 20. When an adhesive is applied to the part where the second part 312 is fitted into the hole 21, it is also desirable that the adhesive have roughly the same dielectric constant and dielectric loss tangent as those of the dielectric layers of the first panel 10 and the second panel 20.

In the examples shown in FIGS. 4A and 4B, the holding part 31A is hooked on the top frame 57A. However, a rail for slidably holding the first part 311 may be provided in the bottom frame 58 (see FIG. 1). In this case, the second part 312 extends in the height (+Z) direction to support the second panel 20 from below. Alternatively, the holding part 31A may be slidably formed on the frame 50 for holding a side edge of the reflection panel 30A. In this case, the first part 311 slides in the longitudinal direction of the reflection panel 30A, and the second part 312 extends and contracts in the lateral direction of the reflection panel 30A. In either configuration, the second panel 20 is movably held relative to the first panel 10.

In the examples of the configuration shown in FIGS. 4A and 4B, the interval G between the first panel 10 and the second panel is determined by the thickness of the top frame 57A and the thickness of the first part 311 of the holding part 31A. The thickness of the top frame 57A and the thickness of the first part 311 may be designed by measuring in advance an interval at which the best power reflection efficiency can be obtained for a used frequency. By using the holding part 31A, the first panel 10 and the second panel 20 can be separately conveyed when they are conveyed to an installation place, and the second panel 20 can be incorporated at a desired position in the first panel 10 at the installation place.

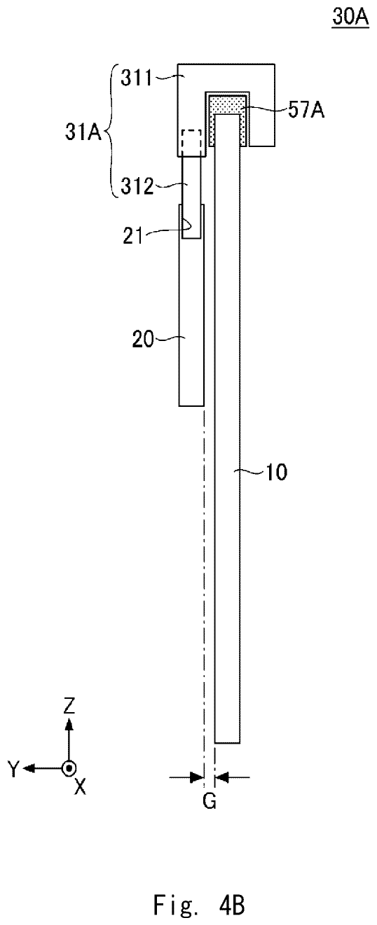

FIG. 5 shows a holding part 31B for holding the second panel 20. The holding part 31B includes a first part 313 which is movable in the first direction of the first panel 10 and a second part 312 which supports the second panel 20 and the length of which can be changed in the second direction of the first panel 10. In the example shown in FIG. 5, the first part 313 has such a hook-like shape that it can be slidably hooked on a slit 522 of a top frame 57B that covers the upper end of the first panel 10.

The second part 312 extends from a tip of the first part 313 opposite to the hook thereof to support the second panel 20. The tip of the second part 312 is fitted into the hole 21 provided in the second panel 20 to support the second panel 20. A part where the second part 312 is fitted into the hole 21 may be reinforced with an adhesive. The second part 312 is slidable in the height direction (the Z direction) relative to the first part 313, so that the length of the holding part 31B can be changed in the Z direction. Locks or latches may be provided at predetermined intervals in the second part 312.

The entire holding part 31B is transparent to electromagnetic waves reflected by the first panel 10 and the second panel 20. Each of the first part 313 and the second part 312 of the holding part 31B preferably has roughly the same dielectric constant and dielectric loss tangent as those of the dielectric layers used in the first panel 10 and the second panel 20, and minimizes an influence on the reflection characteristics of the first panel 10 and the second panel 20. When an adhesive is applied to the part where the second part 312 is fitted into the hole 21, it is also desirable that the adhesive have roughly the same dielectric constant and dielectric loss tangent as those of the dielectric layers of the first panel 10 and the second panel 20.

In the example shown in FIG. 5, although the holding part 31B is hooked on the slit 522 of the top frame 57B and can be slid in the X direction, the bottom frame 58 may include a rail for sliding the first part 313, or the holding part 31B may be slidably formed on the frame 50 for holding a side edge of a reflection panel 30B. By using the holding part 31B, the first panel 10 and the second panel 20 can be separately conveyed when they are conveyed to an installation place, and the second panel 20 can be incorporated at a desired position in the first panel 10 at the installation place.

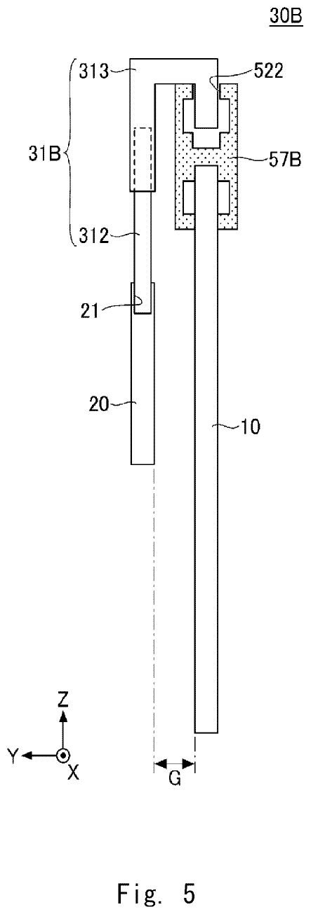

FIG. 6 shows an example of a configuration of the top frame 57B. FIG. 6 is a cross-sectional view along a YZ plane of FIG. 5. The top frame 57B includes a main body 520, a slit 521 and the slit 522 formed on respective sides of the main body 520 in the long axis direction thereof, cavities 523 and 524 respectively communicating with the slits 521 and 522, and grooves 525 and 526 respectively provided in the cavities 523 and 524. The upper end of the first panel 10 is inserted into the slit 521 and fixed by fitting it into the groove 525. The slit 522 on the opposite side is used as a rail for sliding the first part 313 of the holding part 31B. The top frame 57B may have the same shape as that of the frame 50 for holding the adjacent reflection panels 30.

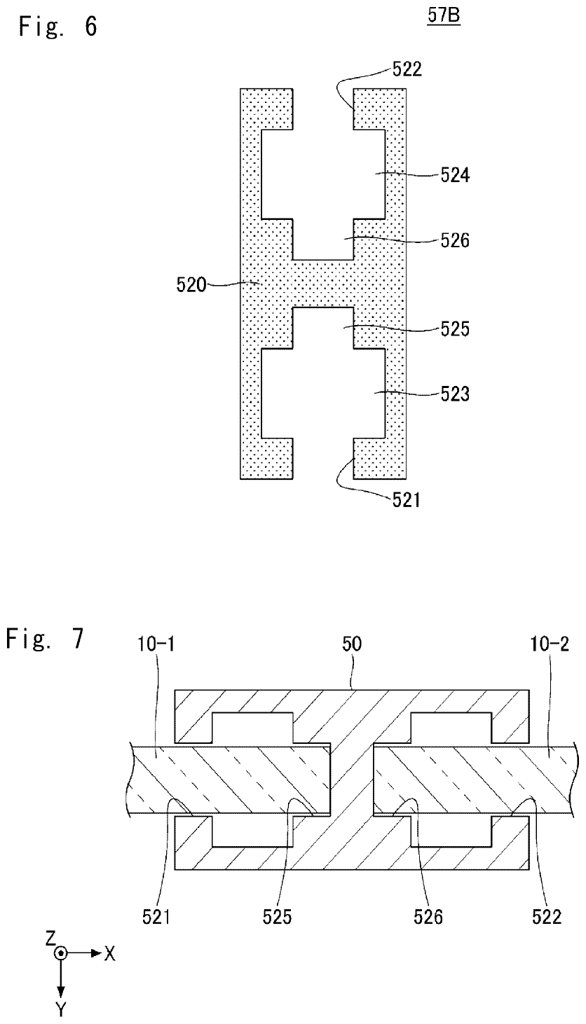

FIG. 7 shows a state in which the adjacent first panels 10-1 and 10-2 are held by the frame 50 having the same shape as that of the top frame 57B. The first panels 10-1 and 10-2 are respectively inserted into the grooves 525 and 526 (see FIG. 6) and are stably held. In order to make the reflection potential between the adjacent first panels 10-1 and 10-2 continuous, at least a part of the frame 50, in particular, the central part of the main body 520 extending between the grooves 525 and 526, is formed of a good conductor. On the other hand, the top frame 57B that receives the holding part 31B may be entirely formed of a non-conductor such as resin.

By attaching the holding part 31B using the top frame 57B, the second panel 20 can be held so that the position thereof relative to the first panel 10 can be adjusted. The first panel 10 and the second panel 20 can be separately conveyed when they are conveyed to an installation place, and the second panel 20 can be incorporated at a desired position in the first panel 10 at the installation place.

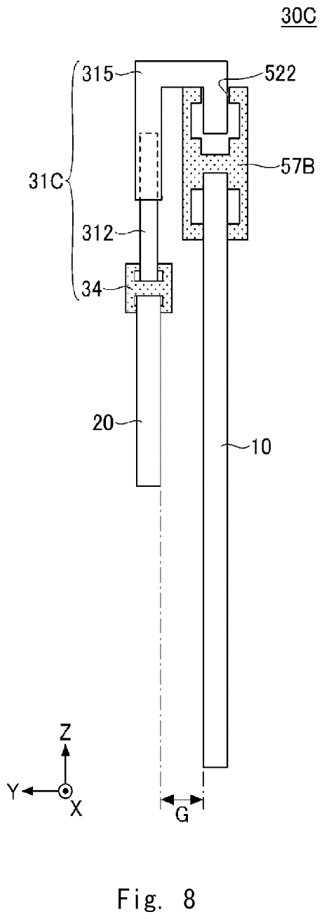

FIG. 8 shows a holding part 31C for holding the second panel 20. The holding part 31C includes a first part 315 which is movable in the first direction of the first panel 10, the second part 312 extending from a tip of the first part 315 and the length of which can be changed in the second direction of the first panel 10, and a socket 34 for holding the second panel 20 at the tip of the second part 312. The first part 315 is movably attached to an edge of the first panel 10 at a desired position thereon. In the example shown in FIG. 8, the first part 315 has such a hook-like shape that it can be slidably hooked on the slit 522 of the top frame 57B that covers the upper end of the first panel 10.

The second part 312 extends from the tip of the first part 315 opposite to the hook thereof, and the length of the second part 312 in the long axis direction can be changed. The tip of the second part 312 and an upper end of the second panel 20 are supported by the socket 34. The second part 312 is slidable in the height direction (the Z direction) relative to the first part 315, so that the length of the holding part 31B can be changed in the Z direction. Locks or latches may be provided at predetermined intervals in the second part 312.

The entire holding part 31C, including the socket 34, is transparent to electromagnetic waves reflected by the first panel 10 and the second panel 20. Each of the first part 315, the second part 312, and the socket 34 of the holding part 31C preferably has roughly the same dielectric constant and dielectric loss tangent as those of the dielectric layers used in the first panel 10 and the second panel 20, and minimizes an influence on the reflection characteristics of the first panel 10 and the second panel 20.

In the example shown in FIG. 8, although the holding part 31C is hooked on the slit 522 of the top frame 57B and can be slid in the X direction, the bottom frame 58 may include a rail for sliding the first part 315, or the holding part 31C may be slidably formed on the frame 50 for holding a side edge of a reflection panel 30C. By using the holding part 31C, the first panel 10 and the second panel 20 can be separately conveyed when they are conveyed to an installation place, and the second panel 20 can be incorporated at a desired position in the first panel 10 at the installation place.

In FIGS. 4A to 8, the holding part 31 is attached using the top frame 57, the bottom frame 58, or the frames 50 for holding the periphery of the reflection panel 30. However, if the strength and the safety of the reflection panel 30 are sufficiently ensured, the holding part 31 may be attached directly to an edge of the reflection panel 30.

### Layer Structure of the Reflection Panel

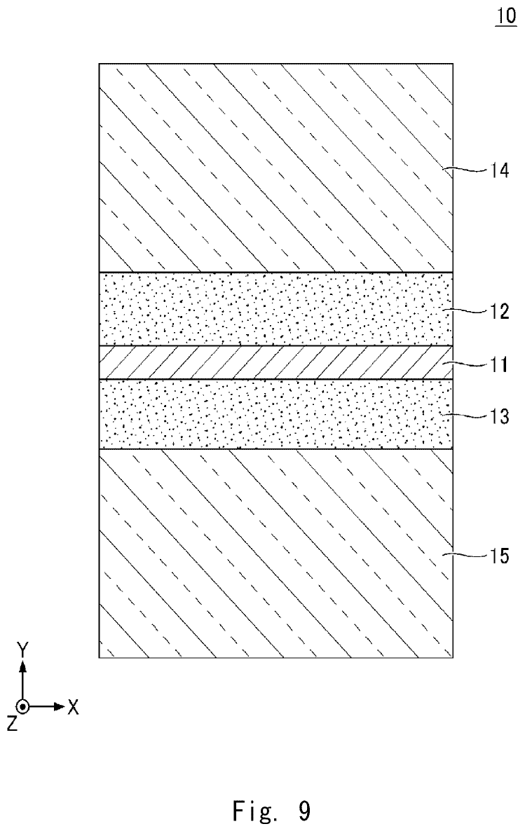

FIG. 9 shows a layer structure of the first panel 10 in the thickness direction (the Y direction). The first panel 10 includes a conductive layer 11 and a dielectric layer 14 or 15 joined to at least one of the surfaces of the conductive layer 11 with an adhesive layer 12 or 13 interposed therebetween. In the example shown in FIG. 9, the conductive layer 11 is interposed between the dielectric layers 14 and 15 with the adhesive layers 12 and 13 respectively interposed therebetween.

The conductive layer 11 is a surface that forms a reflection surface of the first panel 10 and is formed of a metal material suitable for specular reflection. As the material of the conductive layer 11, a good conductor such as Cu, Ni, SUS, Ag, or Au can be used. The conductive layer 11 has a thickness of 10 μm or thicker and 200 μm or thinner, preferably 50 μm or thicker and 150 μm or thinner, so as to sufficiently function as a reflection surface that specularly reflects an electromagnetic wave having a desired frequency.

The adhesive layers 12 and 13 have a transmittance of 60% or higher, preferably 70% or higher, and more preferably 80% or higher for the used frequency so as to guide the incident electromagnetic wave to the conductive layer 11. The adhesive layers 12 and 13 may be made of vinyl acetate resin, acrylic resin, cellulose resin, aniline resin, ethylene resin, silicon resin, or other resin materials. An ethylene-vinyl acetate (EVA: ethylene-vinyl acetate) copolymer or a cycloolefin polymer (COP) may be used in order to make the adhesive layers 12 and 13 durable and moisture-resistant for outdoor use. The thickness of each of the adhesive layers 12 and 13 is such a thickness that the dielectric layers 14 and 15 can be reliably bonded to and held by the conductive layer 11, and is, for example, 10 μm or thicker and 400 μm or thinner. The adhesive layers 12 and 13 have a dielectric constant and a dielectric loss tangent suitable for achieving the target reflection characteristic of the conductive layer 11.

Each of the dielectric layers 14 and 15 is an insulating polymer film made of a polymer material such as polycarbonate, cycloolefin polymer (COP), polyethylene terephthalate (PET), and fluorocarbon resin. In order to make the total amount of the first panel 10 as light as possible while maintaining the strength of the first panel 10, the thickness of each of the dielectric layers 14 and 15 is selected in a range of thicker than 1.0 mm and not thicker than 10.0 mm. When the thickness of the conductive layer 11 is set to 100.0 μm, the ratio of the thickness of each of the dielectric layers 14 and 15 to the thickness of the conductive layer 11 is higher than 10 and not higher than 80. By setting the ratio of the thickness of each of the dielectric layers 14 and 15 to the thickness of the conductive layer 11 in the aforementioned range, the first panel 10 has a mechanical strength strong enough to withstand outdoor use, and hence the target reflection characteristic can be achieved. In a situation where a priority is put on the mechanical strength, the ratio of the thickness of the dielectric material to the conductive layer 11 may be increased within a range where the reflection characteristic is not hindered.

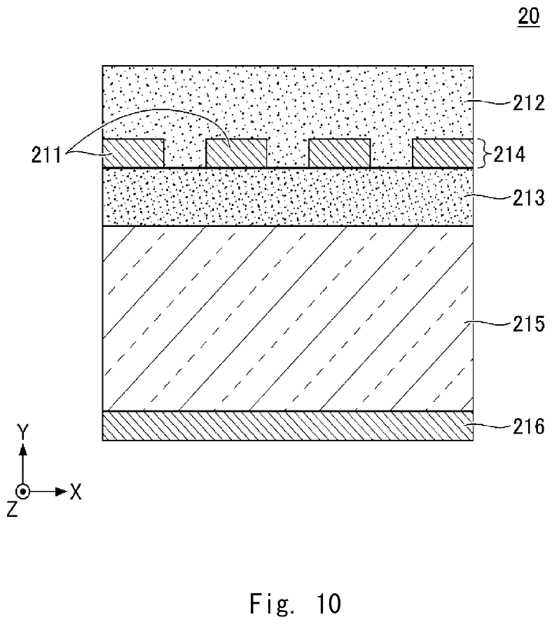

FIG. 10 shows a layer structure of the second panel 20 in the thickness direction (the Y direction). The second panel 20 includes a dielectric layer 215, a conductive layer 214 held by an adhesive layer 213 on one surface of the dielectric layer 215, and a protective layer 212 that covers the conductive layer 214. The dielectric layer 215 is an insulating polymer film made of a polymer material such as polycarbonate, cycloolefin polymer (COP), polyethylene terephthalate (PET), and fluorocarbon resin, and has a thickness of about 0.3 mm to 1.0 mm. The dielectric layer 215 may be formed of any material having a dielectric constant and a dielectric loss tangent suitable for achieving the target reflection characteristic. A ground layer 216 is formed on a surface of the dielectric layer 215 opposite to the conductive layer 214.

The conductive layer 214 forms a meta-surface of the second panel 20, that is, a surface having an artificially controlled reflection characteristic. The conductive layer 214 has a predetermined pattern which is formed of metal patches 211 formed of a good conductor such as Cu, Ni, Ag, or Au. The conductive layer 214 has a thickness that enables an incident electromagnetic wave to be reflected in a designed direction with a sufficient intensity, for example, a thickness of 10 μm to 50 μm.

The adhesive layer 213 is formed of a material capable of supporting the metal patches 211 and fixing them to the dielectric layer 215. As the material of the adhesive layer 213, a thermoplastic resin, such as a vinyl acetate resin, an acrylic resin, a cellulose resin, or a silicone resin, may be used. The adhesive layer 213 has a thickness of about 5 μm to 50 μm. The protective layer 212 that covers the conductive layer 214 is desirably durable and moisture-resistant, and for example, an ethylene-vinyl acetate (EVA) copolymer or a cycloolefin polymer (COP) can be used. The protective layer 212 has a thickness of 10 μm to 400 μm. The protective layer 212 may be formed of an adhesive layer to fix a dielectric substrate made of polycarbonate or the like on a surface of the protective layer 212.

### Evaluation of the Reflection Panel

The reflection characteristic of the reflection panel 30 is evaluated by combining the first panel 10 shown in FIG. 9 with the second panel 20 shown in FIG. 10. It is presumed that the interval G between the first panel 10 and the second panel 20, that is, the thickness of the air layer, affects the characteristic of the reflection panel 30. The reflection characteristic is evaluated by variously changing the interval G.

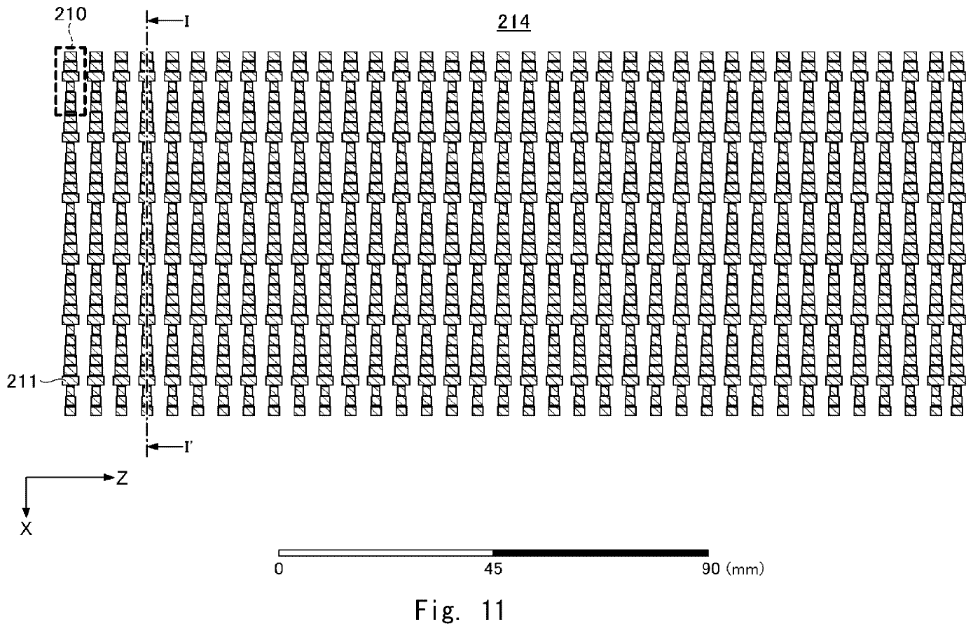

FIG. 11 shows a model of a conductive pattern used for the conductive layer 214 of the second panel 20. The model for evaluating the conductive layer 214 includes a periodic array of unit cells (also referred to as “supercells”) 210. The unit cells 210 are arranged in six rows in the X direction and 36 columns in the Z direction, and form a meta-surface that reflects an electromagnetic wave at an angle different from the incident angle thereof. The X and the Z directions respectively correspond to the X and the Z directions in FIG. 1.

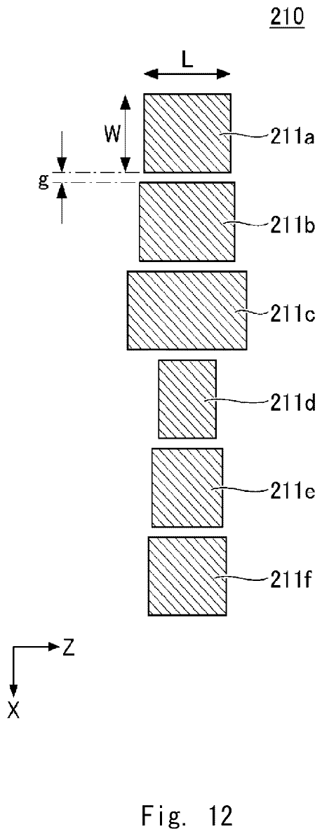

FIG. 12 is a schematic diagram showing a structure of the unit cell 210. The unit cell 210 is formed of six metal patches 211a, 211b, 211c, 211d, 211e, and 211f (may be collectively referred to as “metal patches 211” as appropriate). The metal patches 211a to 211f have the same width (W) and lengths (L) different from one another, but have the same central axis of the length (L). The pitch between the metal patches in the X direction is fixed. The phase of reflection is controlled by the shapes and the sizes of the metal patches 211a to 211f and the intervals in the X direction therebetween, and a reflection beam is formed in a desired direction by superimposing reflected waves. In this example, the unit cell 210 is designed so that the peak of a reflected wave of an electromagnetic wave which is perpendicularly incident (an incident angle 0°) appears in a direction of 50° from the normal.

In the evaluation method, the second panel 20 shown in FIGS. 10 to 12 is held at a predetermined interval G from the first panel 10 shown in FIG. 9. A plane wave of 28.0 GHz is made incident at an incident angle of 0°, and the scattering cross section of the reflected wave is analyzed by using general-purpose three-dimensional electromagnetic field simulation software. The scattering cross section, namely, a Rader Cross Section (RCS), is used as an index of the ability to reflect an incident electromagnetic wave.

In the case of a meta-surface that reflects an incident electromagnetic wave at a reflection angle different from the incident angle thereof, a calculated power reflection efficiency need to be corrected. While the first panel 10 has a specular reflection surface and reflects an electromagnetic wave in the same direction for perpendicular incidence, the meta-surface of the second panel 20 reflects an electromagnetic wave in a direction different from the incident angle thereof. The power reflection efficiency of the meta-surface is a value obtained by dividing the power reflection efficiency obtained from a gain value by a correction value. In order to improve a radio wave environment by using the reflection panel 30, the power reflection efficiency is set to 65% or more, preferably 70% or more, and more preferably 75%. When the power reflection efficiency becomes lower than 65%, it becomes difficult to obtain a sufficient effect of improving a radio wave environment.

If a reflected electric field in the meta-surface without loss determined by the model pattern shown in FIG. 11 is E_{MR} and a reflected electric field in an ideal conductive plate is E_{PEC}, a correction value εₚ is |E_{MR}/E_{PEC}|². |E_{MR}/E_{PEC}| is expressed as follows.

$$\vert \frac{{E}_{MR}}{{E}_{PEC}} \vert = \frac{\sqrt{\vert cos θ \vert}}{\vert cos φ \vert} \qquad [ Expression 1 ]$$

or

$$\vert \frac{{E}_{MR}}{{E}_{PEC}} \vert = \frac{\sqrt{\vert cos {θ}_{i} \cdot cos {θ}_{r} \vert}}{\vert cos φ \vert} \qquad [ Expression 2 ]$$

where θ is an incident angle on the meta-surface and φ is a corresponding reflection angle in the case of regular reflection. If the reflection angle of the meta-surface is θ=50° or θr=50°, the incident angle is θi=0°, and the reflection angle of regular reflection is φ=25°, the correction value εₚ is 0.7826.

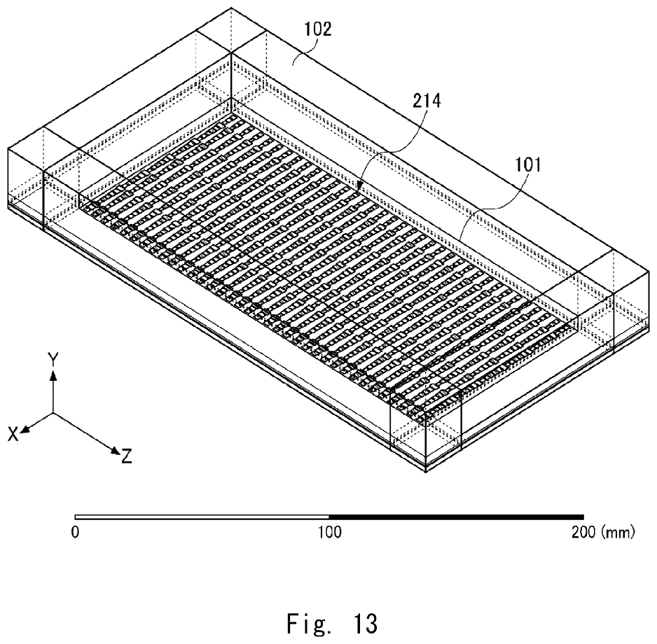

FIG. 13 shows an analysis space 101 for an electromagnetic wave simulation. The analysis space 101 is expressed by (a size in the X direction)×(a size in the Z direction)×(a size in the Y direction) by defining the thickness direction of the layer structure shown in FIG. 10 as the Y direction, the width direction of the metal patch 211 of the model shown in FIG. 11 as the X direction, and the length direction of the same as the Z direction. It is assumed that the size of the analysis space 101 when the frequency of the incident electromagnetic wave is 28.0 GHz is 83.9 mm×192.6 mm×3.7 mm. It is assumed that the boundary condition is a design in which an electromagnetic wave absorber 102 is disposed on the periphery of the analysis space 101.

### Example 1

Example 1 is Implementation Example 1 (i.e., Example 1 according to the present disclosure). A panel having the layer structure shown in FIG. 9 having a plane size of 1.0 m in length and 2.0 m in width is used as the first panel 10. A polycarbonate sheet having a length of 1.0 m, a width of 2.0 m, and a thickness of 2.0 mm is used as each of the outermost dielectric layers 14 and 15. Two polycarbonate sheets are bonded to respective sides of the conductive layer 11 formed of a stainless steel mesh having a thickness of 100 μm with the adhesive layers 12 and 13 of ethylene vinyl acetate each having a thickness of 400 μm respectively interposed therebetween.

A panel having the layer structure shown in FIG. 10 and the conductive pattern shown in FIG. 11 having a plane size of 0.7 m in length and 0.7 m in width is used as the second panel 20. A polycarbonate sheet having a length of 0.7 m, a width of 0.7 m, and a thickness of 0.7 mm is used as the dielectric layer 215. The ground layer 216 formed of an Ag-based multilayer film having a thickness of 0.36 mm is provided on one side of the polycarbonate sheet, and the conductive layer 214 including the metal patch 211 formed of copper foil having a thickness of 0.03 mm is provided on the other side of the polycarbonate sheet with the adhesive layer 213 having a thickness of 0.01 mm interposed therebetween. The protective layer 212 of EVA having a thickness of 400 μm is provided so as to cover the conductive layer 214.

The second panel 20 is disposed at the interval G=0.0 mm from the first panel 10. A gain value (a peak value of a reflected waveform) at 50° in the RCS plot when an electromagnetic wave incident at an incident angle of 0° is reflected at a reflection angle of 50° is −1.5297 dB. A power reflection efficiency after this gain value is corrected by the correction value εₚ=0.7826 is 77.2%. When the interval G is 0.0 mm, a high power reflection efficiency exceeding 75% can be obtained.

### Example 2

Example 2 is Implementation Example 2. The configurations and the shapes of the first and the second panels 10 and 20 are the same as those of the first and the second panels 10 and 20 in Example 1. The second panel 20 is disposed at the interval G=1.0 mm from the first panel 10. A gain value (a peak value of a reflected waveform) at 50° in the RCS plot when an electromagnetic wave incident at an incident angle of 0° is reflected at a reflection angle of 50° is −1.4541 dB. A power reflection efficiency after this gain value is corrected by the correction value εₚ=0.7826 is 78.5%. When the interval G is 1.0 mm, a high power reflection efficiency exceeding 75% can be obtained.

### Example 3

Example 3 is Implementation Example 3. The configurations and the shapes of the first and the second panels 10 and 20 are the same as those of the first and the second panels 10 and 20 in Example 1. The second panel 20 is disposed at the interval G=5.0 mm from the first panel 10. A gain value (a peak value of a reflected waveform) at 50° in the RCS plot when an electromagnetic wave incident at an incident angle of 0° is reflected at a reflection angle of 50° is −1.7936 dB. A power reflection efficiency after this gain value is corrected by the correction value εₚ=0.7826 is 72.6%. When the interval G is 5.0 mm, a high power reflection efficiency exceeding 70% can be obtained.

### Example 4

Example 4 is Implementation Example 4. The configurations and the shapes of the first and the second panels 10 and 20 are the same as those of the first and the second panels 10 and 20 in Example 1. The second panel 20 is disposed at the interval G=10.0 mm from the first panel 10. A gain value (a peak value of a reflected waveform) at 50° in the RCS plot when an electromagnetic wave incident at an incident angle of 0° is reflected at a reflection angle of 50° is −1.7661 dB. A power reflection efficiency after this gain value is corrected by the correction value εₚ=0.7826 is 73.1%. When the interval G is 10.0 mm, a high power reflection efficiency exceeding 70% can be obtained.

### Example 5

Example 5 is Implementation Example 5. The configurations and the shapes of the first and the second panels 10 and 20 are the same as those of the first and the second panels 10 and 20 in Example 1. The second panel 20 is disposed at the interval G=20.0 mm from the first panel 10. A gain value (a peak value of a reflected waveform) at 50° in the RCS plot when an electromagnetic wave incident at an incident angle of 0° is reflected at a reflection angle of 50° is −1.4887 dB. A power reflection efficiency after this gain value is corrected by the correction value εₚ=0.7826 is 77.9%. When the interval G is 20.0 mm, a high power reflection efficiency exceeding 75% can be obtained.

### Example 6

Example 6 is Implementation Example 6. The configurations and the shapes of the first and the second panels 10 and 20 are the same as those of the first and the second panels 10 and 20 in Example 1. The second panel 20 is disposed at the interval G=50.0 mm from the first panel 10. A gain value (a peak value of a reflected waveform) at 50° in the RCS plot when an electromagnetic wave incident at an incident angle of 0° is reflected at a reflection angle of 50° is −1.8146 dB. A power reflection efficiency after this gain value is corrected by the correction value εₚ=0.7826 is 72.3%. When the interval G is 50.0 mm, a high power reflection efficiency exceeding 70% can be obtained.

### Example 7

Example 7 is Implementation Example 7. The configurations and the shapes of the first and the second panels 10 and 20 are the same as those of the first and the second panels 10 and 20 in Example 1. The second panel 20 is disposed at the interval G=90.0 mm from the first panel 10. A gain value (a peak value of a reflected waveform) at 50° in the RCS plot when an electromagnetic wave incident at an incident angle of 0° is reflected at a reflection angle of 50° is −1.7730 dB. A power reflection efficiency after this gain value is corrected by the correction value εₚ=0.7826 is 73.0%. When the interval G is 90.0 mm, a high power reflection efficiency exceeding 70% can be obtained.

### Example 8

Example 8 is Comparative Example 7. The configurations and the shapes of the first and the second panels 10 and 20 are the same as those of the first and the second panels 10 and 20 in Example 1. The second panel 20 is disposed at the interval G=100.0 mm from the first panel 10. A gain value (a peak value of a reflected waveform) at 50° in the RCS plot when an electromagnetic wave incident at an incident angle of 0° is reflected at a reflection angle of 50° is −2.2818 dB. A power reflection efficiency after this gain value is corrected by the correction value εₚ=0.7826 is 64.9%. When the interval G is 100.0 mm, a power reflection efficiency is less than 65%, and thus it is difficult to expect a sufficient improvement of the radio wave environment.

From the results of Examples 1 to 8, it is desirable that the interval G between the first panel 10 and the second panel 20 be an interval of 0.0 mm or longer and less than 100.0 mm in a direction perpendicular to the panel surface of the reflection panel 30. By holding the second panel 20 at the interval G from the first panel 10, an incident electromagnetic wave can be reflected in a designed direction with a sufficient reflection intensity. By movably holding the second panel 20 in the plane of the first panel 10, the position of the second panel 20 can be adjusted to an optimal position in accordance with an arrival direction of an electromagnetic wave and a direction in which the electromagnetic wave is to be reflected. It is also possible to hold two or more second panels 20 for one first panel 10 while keeping the above-described range of the interval G. By using a plurality of second panels 20, the area of irregular reflection can be expanded. Since the first panel 10 of specular reflection having a large area can be easily fabricated, a plurality of second panels 20 can be movably held relative to the first panel 10 having a size of, for example, 3.0 m×3.0 m. By using the first panel 10, an area in which a radio wave propagation environment can be improved by a panel having a large area where the power reflection efficiency thereof is close to 100% can be expanded. By using the second panel 20, a radio wave propagation environment of an area that cannot be covered by specular reflection can be improved.

Although the embodiments according to the present disclosure have been described above, the present disclosure is not limited to the above-described embodiments. A transparent wire of a winding type, instead of a slider mechanism, may be used as the second part 312 of the holding part 31, and may be combined with a transparent hook that serves as the first part. If the strength and the safety of the reflection panel 30 are sufficiently ensured, only one of the top frame 57, the bottom frame 58, or the frames 50 which are side frames may be used. When a plurality of electromagnetic-wave reflecting apparatuses 60 are connected to one another, it is desirable that at least a part of the frame 50, specifically, a part connecting the edges of two adjacent first panels 10 to each other, be formed of a conductor in order to make the reflection potential between the adjacent first panels 10 of the reflection panels 30 continuous. When one electromagnetic-wave reflecting apparatus 60 is used alone, the second panel 20 may be movably held relative to the first panel 10 by using the side frames 50.

The above disclosure may include the following embodiments.

### (Item 1)

A reflection panel comprising:
a first panel configured to specularly reflect an electromagnetic wave in a desired band selected from a frequency band of 1 GHz or higher and 300 GHz or lower; and
a second panel including a meta-surface having a controlled reflection characteristic,
wherein an interval between the first panel and the second panel in a direction perpendicular to a panel surface is an interval of 0.0 mm or longer and less than 100.0 mm.

### (Item 2)

The reflection panel according to Item 1, wherein the second panel is disposed on a side of the first panel on which the electromagnetic wave is incident.

### (Item 3)

The reflection panel according to Item 1 or 2, wherein a plane size of the second panel is smaller than a plane size of the first panel.

### (Item 4)

The reflection panel according to any one of Items 1 to 3, wherein the second panel is held so as to be movable relative to the first panel or detachable from the first panel.

### (Item 5)

The reflection panel according to any one of Items 1 to 4, comprising a holding part configured to hold the second panel, the holding part being attached to a part of an edge of the first panel so as to be movable or detachable.

### (Item 6)

The reflection panel according to Item 5, wherein the holding part comprises a first part configured to be movable along a first edge of the first panel in a first direction, and a second part configured to support the second panel, a length of the second part being able to be changed in a second direction different from the first direction.

### (Item 7)

An electromagnetic-wave reflecting apparatus comprising:
a reflection panel configured to reflect an electromagnetic wave in a desired band selected from a frequency band of 1 GHz or higher and 300 GHz or lower; and
a frame configured to hold the reflection panel, wherein
the reflection panel comprises a first panel configured to specularly reflect the electromagnetic wave, and a second panel including a meta-surface having a controlled reflection characteristic, and
an interval between the first panel and the second panel in a direction perpendicular to a panel surface of the reflection panel is an interval of 0.0 mm or longer and less than 100.0 mm.

### (Item 8)

The electromagnetic-wave reflecting apparatus according to Item 7, wherein the second panel is disposed on a side of the first panel on which the electromagnetic wave is incident.

### (Item 9)

The electromagnetic-wave reflecting apparatus according to Item 7 or 8, wherein a plane size of the second panel is smaller than a plane size of the first panel.

### (Item 10)

The electromagnetic-wave reflecting apparatus according to any one of Items 7 to 9, wherein the second panel is held so as to be movable relative to the first panel or detachable from the first panel.

### (Item 11)

The electromagnetic-wave reflecting apparatus according to any one of Items 7 to 10, wherein
the frame includes a top frame for holding an upper end of the first panel, side frames for holding side ends of the first panel, or a bottom frame for holding a lower end of the first panel, and
the second panel is held so as to be movable relative to the first panel or detachable from the first panel by using a part of the top frame, the side frames, or the bottom frame.

### (Item 12)

The electromagnetic-wave reflecting apparatus according to Item 11, comprising a holding part configured to hold the second panel relative to the first panel,
wherein the holding part comprises a first part configured to be movable in a first direction along the top frame, the side frames, or the bottom frame, and a second part configured to support the second panel, a length of the second part being able to be changed in a second direction different from the first direction.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A reflection panel comprising:
a first panel configured to specularly reflect an electromagnetic wave in a desired band selected from a frequency band of 1 GHz or higher and 300 GHz or lower; and
a second panel including a meta-surface having a controlled reflection characteristic,
wherein an interval between the first panel and the second panel in a direction perpendicular to a panel surface is an interval of 0.0 mm or longer and less than 100.0 mm.

2. The reflection panel according to claim 1, wherein the second panel is disposed on a side of the first panel on which the electromagnetic wave is incident.

3. The reflection panel according to claim 1, wherein a plane size of the second panel is smaller than a plane size of the first panel.

4. The reflection panel according to claim 1, wherein the second panel is held so as to be movable relative to the first panel or detachable from the first panel.

5. The reflection panel according to claim 1, comprising a holding part configured to hold the second panel, the holding part being attached to a part of an edge of the first panel so as to be movable or detachable.

6. The reflection panel according to claim 5, wherein the holding part comprises a first part configured to be movable along a first edge of the first panel in a first direction, and a second part configured to support the second panel, a length of the second part being able to be changed in a second direction different from the first direction.

7. An electromagnetic-wave reflecting apparatus comprising:
a reflection panel configured to reflect an electromagnetic wave in a desired band selected from a frequency band of 1 GHz or higher and 300 GHz or lower; and
a frame configured to hold the reflection panel, wherein the reflection panel comprises a first panel configured to specularly reflect the electromagnetic wave, and a second panel including a meta-surface having a controlled reflection characteristic, and
an interval between the first panel and the second panel in a direction perpendicular to a panel surface of the reflection panel is an interval of 0.0 mm or longer and less than 100.0 mm.

8. The electromagnetic-wave reflecting apparatus according to claim 7, wherein the second panel is disposed on a side of the first panel on which the electromagnetic wave is incident.

9. The electromagnetic-wave reflecting apparatus according to claim 7, wherein a plane size of the second panel is smaller than a plane size of the first panel.

10. The electromagnetic-wave reflecting apparatus according to claim 7, wherein the second panel is held so as to be movable relative to the first panel or detachable from the first panel.

11. The electromagnetic-wave reflecting apparatus according to claim 7, wherein
the frame includes a top frame for holding an upper end of the first panel, side frames for holding side ends of the first panel, or a bottom frame for holding a lower end of the first panel, and
the second panel is held so as to be movable relative to the first panel or detachable from the first panel by using a part of the top frame, the side frames, or the bottom frame.

12. The electromagnetic-wave reflecting apparatus according to claim 11, comprising a holding part configured to hold the second panel relative to the first panel,
wherein the holding part comprises a first part configured to be movable in a first direction along the top frame, the side frames, or the bottom frame, and a second part configured to support the second panel, a length of the second part being able to be changed in a second direction different from the first direction.
